(19) United States
(12) Patent Application Publication
(10) Pub. No.: US 2013/0196138 A1
(43) Pub. Date: Aug. 1, 2013

(54) Fiber Reinforced Putty, Device And Method For Its Manufacture, Device And Method To Make Laminates And Other Finished Parts From The Putty, And A Laminate Made From The Putty

(71) Applicant: Luciano Fusco, Genova (IT)

(72) Inventor: Luciano Fusco, Genova (IT)

(21) Appl. No.: 13/636,458

(22) PCT Filed: Mar. 21, 2011
(86) PCT No.: PCT/EP11/01395

§ 371 Date: Nov. 29, 2012

(30) Foreign Application Priority Data
Mar. 21, 2010 (EP) PCT/EP2010/001791

(51) Int. Cl. B29C 70/70; C08L 57/10; C08K 7/14; B32B 17/04

(52) U.S. Cl. CPC B29C 70/70; B32B 17/04; C08L 57/10; C08K 7/14
USPC 428/300.7; 264/299; 264/319; 264/328.17; 264/478; 264/496; 156/380.9; 156/229; 156/199; 524/556; 422/135

(57) ABSTRACT

The invention relates to a filamentized fiber reinforced putty compound, to parts made from said putty, and to devices and methods for manufacturing both the putty and the parts. The compound of the invention is formed by a chopped fibers composition including monofilaments that have been broken down from chopped strands and a UV and/or chemical curable resin composition and is a ready-to-mold plastic putty used in molding, mainly by continuous lamination/pultrusion/extrusion and injection. The putty fiber reinforcement, whose weight makes up between 10 and 50% of the total weight of the putty, more particularly in the range of 20 to 40%, is formed by one of the group consisting of at least one type of chopped strands that has been entirely broken down into filaments, and at least one type of chopped strands that has been entirely broken down into filaments in combination with at least one type of chopped strands that has been left intact; each one of the types of fibers involved in the same composition is chopped in one or more lengths of between 3 and 50 mm, with the bulk preferably being between 12 and 30 mm; the percentage of the fiber filaments in the putty being the amount necessary and sufficient to capillarity reinforce the resin thoroughly and everywhere in the putty.

### FIELD OF THE INVENTION

The present invention relates generally to composite materials that can broadly be associated with or referred to FRP (fiber reinforced plastic) or GRP (glassfiber reinforced plastic), and more particularly, to a composite material in the form of a ready-to-mold filamentized fiber reinforced putty compound used in molding, mainly by continuous lamination/pultrusion/extrusion and injection. The compound of the invention is formed by a chopped fibers composition including monofilaments that have been broken down from chopped strands and a UV and/or chemical curable resin composition. The invention also relates to parts and laminates made from said putty and to devices and methods for manufacturing both the putty and the parts made from the putty.

### BACKGROUND OF THE INVENTION AND PRIOR ART

Technologies for manufacturing FRP parts were disclosed in U.S. Pat. No. 6,627,022 and U.S. Pat. No. 7,160,605, European Application EP 03 704 113.4, PCT Intl. applications PCT/BR03/00016, and PCT/IB2008/003778 and Brazilian patents PI 9403679-9, PI 9802274-1 and PI 0201285-5, all of them to Fusco. In general, those technologies, although providing good manufacturing results, needed high capital disbursement, the machinery involved was difficult to operate and to control, requiring big working space and a large number of working steps, leading to a lower degree of efficiency, economy, production quality, and environmental friendliness as compared to the technology of the invention.

In general, closed-mold technology for manufacturing FRP parts known in the art is sophisticated, expensive and requires tooling involving long lead time. Continuous lamination technology known in the art provides machines that are bulky and slow because they cut the fiber online, then impregnate the fiber with resin so as to form the composite online and then cures the composite by heating online. These systems require time for wetting the fiber and time for hardening the resin, and these times determine how long the lamination machine must be as well as affecting the operation speed. In machines using the technology known in the art, operation speed is substantially proportional to the length of the machine used for manufacturing, with the result that a normal production using conventional technology, if operating at a speed of 3 m/min, requires an average length of 75 m, and if operating at a speed of 6 m/min would require an average length of 150 m. The longer the machine, the more complex the production process, the more the manpower required, and the higher the production costs; moreover, a long machine reduces the quality of the laminate produced.

In addition, the mentioned prior art systems are affected by concerns such as producing parts having waves, crisp cellulite texture or orange peel and marks on the surfaces, caused by irregular shrinkages of the resin, the need for lengthy and expensive finishing operations, such systems also requiring cutting of the edges of the laminate, and causing dirt and pollution in the working environment, waste of materials, styrene emissions, generation of glass particles in the air and large amount of scrap of FRP and plastic films, which are materials difficult to dispose of.

### Terminology

Single, indivisible and elementary glassfiber filaments or monofilaments that are totally released, separated, or broken down from at least one type of chopped fiber strands of the composition formed by one or more types of chopped strands in the manufacture of the putty compound, will be henceforth referred to as “monofilaments or “filaments”.

UV curable and/or chemical catalyst curable resin composition matrix (meaning that the resin can be cured by both UV and chemical curing agents, simultaneously in a mixed curing system or separately), comprising resins and curing agents, optionally including fillers, additives, processing aids and pigments, will be henceforth referred to as “resin”.

Isotropic squeezable FRP molding putty compound, substantially colloidal and practically homogeneous, which includes glassfiber monofilaments and UV/chemical curable resin, will henceforth be referred to as “putty”.

High frequency vibration necessary and sufficient to totally separate or break down into monofilaments at least one type of chopped fiber strands that have been wet with resin, the vibration being generated either mechanically, electrically, pneumatically, hydraulically or ultrasonically and/or by their combination, will henceforth be referred to as “vibration”.

The treatment given to a plastic release film so as to make it bondable, or capable of crosslinking with the resin at the surface of a strip or layer of FRP putty and/or with another plastic film, the treatment being either in the form of a layer of resin that is coextruded with the primary film or in the form of a plastic resin ink, the treatment being either transparent or pigmented such that it forms images, text or design, which is preprinted on such film, will henceforth be referred to simply as “ink”.

### Remarks About “Filamentization” of Glassfiber in the Prior Art

Glassfiber reinforcement fiber is primarily obtained in the form of monofilaments on a spinneret or bushing (a cap or plate with a number of small holes through which a fiber-forming solution is forced). The so-formed monofilaments are gathered into strands, because it is the only way to make the glassfiber workable, meaning able to be wound into bobbins, cut or chopped, woven or manipulated whatsoever. In other words, glassfiber monofilaments cannot be used in a workable way unless they are bonded together by sizing, to form strands. One glassfiber strand is usually formed by many hundreds or thousands of single filaments.

Sizing is essential to glassfiber manufacture and critical to several key fiber characteristics that determine both how fibers will handle during processing and how they perform as part of a composite. It is well known in the art that without sizing, it would be difficult even to make glass roving. Raw fibers are abrasive and easily abraded; so it is necessary to protect fibers from their neighbor fibers. Without sizing, handling glassfiber would lead to having nothing but fuzz. When fibers, in the form of chopped fiber strands are added to a composite so as to reinforce a resin, because of their shape and crossing or interlacing, a plurality of void spaces between them are created; these spaces are filled with resin, and this causes a plurality of irregular shrinkages upon curing of the composite that translate into deformations on the surfaces of the manufactured parts; in other words, the mix of strands and resin is far from behaving as a homogeneous material.

How to remedy this problem has always been crucial for glassfiber manufacturers and operators in the FRP market. Several systems, such as using low-profile resins, gelcoat, fillers, surface mats, veils etc., have been proposed, with only partial success. It is obvious that the ideal solution would be to filamentize the chopped strands, that is, to discover a practical system for reconverting the chopped strands back to single filaments, making the resin-fiber mixture homogeneous, whilst yielding strong manufactured parts using them.

One skilled in the art knows that, for reasons that remain unclear and controversial, when one tries to totally breakdown chopped strands into monofilaments, when the strands are more than 3 mm long and comprise more than 5% in weight of the resin-fiber composition, and to disperse them into a resin matrix by agitation (meaning by moving them with any kind of rotating, swirling or flowing motion whatsoever), the monofilaments entangle with each other, irreversibly flocculating, forming useless spongy lumps, like cotton candy or spun sugar. When it comes to strength, the minimum amount of fiber content needed so as to serve effectively as reinforcement is about 10% of the total weight of the resin-fiber composition. Below this value, the fiber behaves just as filler, not as reinforcement. Until now, it has been an unsolved problem in the art as to how to create a real “filamentized” mixture of resin and long monofilaments, these long filaments making up the sufficient percentage weight in the resin-fiber mixture necessary to serve as reinforcement, with the term “filamentized” meaning a total separation of long strands into long filaments.

Since the discovery of glassfiber as reinforcement for composites, the art has been enriched of theories on “filamentized” fiber, yet none have reached the expected industrial applicability. Such theories, some of which are cited below, broadly, dubiously, and ambiguously associate the term “filamentized” with the idea of providing a softer and smoother fibrous structure that could palliate the surfaces deformations, and yet implicitly assuming the impossibility of using individually glassfiber monofilaments as reinforcement, they use the term “filamentization” with no explanation of how such “filamentization” takes place or what it consists of.

Devoid of norms and aggravated by the very nature of the material, the fiber terminology, in its many industrial forms, is confused. Assuming that cords (roving or yarn) are formed by strands, that strands are formed by monofilaments, and that a monofilament is the minimum, single and indivisible fiber element, people commonly misname fibers; it is common to misname roving as strands, and strands as monofilaments, as in the case of the technique known as “filament-winding”, wherein not monofilaments, but strands, are used; or in the so-called “glassfiber putty” which contains no fiber, but instead contains glass-powder; or yet, when the strands are so finely chopped that they disintegrate or indeed “filamentize” since the strands lose their integrity only because the sizing is no longer capable of holding such very short monofilaments together, similar to what occurs with wood that crumbles if it is finely sliced across the grain or fibers.

Important glossaries in this field define TEX as “grams per 1 km of yarn, filament, fiber, or strand”. In addition, pursuant to many texts published in the art, it can also be interpreted that filamentized fiber means having thinner strands, that is, having strands formed by a smaller number of filaments and being softer than the average strands. To yet other technicians, the term “filamentized” means the separation (de-bundling) of fiber bundles of roving into strands.

U.S. Pat. No. 7,026,043 to Jander—Owens Corning Composites, reveals a method for avoiding the above mentioned problems of the surface of parts made of SMC, by compounding the sheet (ply) as follows:
a) when the part is made with a single ply or sheet, the U.S. Pat. No. '043 masks the appearance of the structural chopped-strands' texture on the surface of the molded part by a top layer, acting as a barrier. The top layer is textually defined as being “a resin impregnated chopped and filamentized fiber layer”and the fiber is defined textually as “chopped and filamentized or milled fibers mixed between about 0.25 and 30% by weight in the formulation without fillers. Any suitable fiber that may be filamentized, flaked or milled can be used in the invention”: However, the '043 patent remains silent as how the fiber is “filamentized” and how long the filaments are, although the association of such “filamentized” fiber with milled-fiber and fiber-flakes is obvious. The main and structural SMC sheet layer is textually defined as being “a resin impregnated unfilamentized or partially filamentized fiber layer”, wherein the fiber is textually defined as “a plurality of chopped unfilamentized fibers”.
b) when the part is made with more than one ply, due to the thickness of the part, the '043 patent proposes a top layer on the top of the multi-ply sheet and one or more plies of conventional SMC below, such as those made according to the prior art, placed in the mold. This would form a composite part having a Class A top surface side on a visible side of the composite part, and a non-class A bottom surface that is usually found on the non-visible side. If both the top and bottom surface of the part would need Class A surfaces, then a top layer and bottom layer of the compacted SMC sheet would be used, with one or more plies of sheet molding compound made according to the prior art contained within these top sheets.

According to the disclosure of U.S. Pat. No. '043, fiber is “filamentized”before adding it to the resin. If fibers can be either in the form of milled fiber or fiber flakes, this means that the “filamentized”fibers used in the '043 patent are very short, less than 1 mm, and that they can be added and mixed into the resin only because they are cut, crushed or ground into fine particles, which is opposite to the technology according to the present invention in which long filaments are separated from chopped strands after these are mixed with the resin. Cut short, milled or flaked fibers fulfill the object of the '043 patent to create a barrier to mask the texture of the main fiber core or substrate formed by strands, but they do not serve as structural reinforcement, able to impart or determine tensile/flexural strength, which, on the contrary, is one of the objects of the present invention. This fact also explains why the '043 patent uses the “filamentized fiber layer” on the top surfacing layer only, and not in compounding the main and structural fiber reinforced core layers of the SMC compound.

Published U.S. patent application Ser. No. 12/032,870, to Diwanji et Allies—Owens Corning Science & Technology Center—Granville, Ohio, discloses a roofing product including a structural layer of composite material and a gel coat cover layer. It explains that “the structural layer of composite material is formed by (a) a substantially homogeneous matrix of gypsum material and a polymer resin material and (b) wet-used chopped strand fibers. The wet-used chopped strand fibers are substantially filamentized with the substantially homogeneous matrix, wherein, in forming the composite material, bales of the wet-used chopped strand reinforcing fibers may be filamentized by any type of suitable opening system, such as bale opening systems, which are common in the industry. The opening system serves both to decouple the loosely clustered strands of the wet-used chopped strands and to enhance the fiber-to-fiber contact. That is, when the wet-used chopped strand fibers are filamentized (i.e., substantially evenly separated and well-distributed) within the gypsum urea formaldehyde mixture, substantially all of the wet-used chopped strand fibers are in direct contact with the substantially homogeneous matrix.” Clearly, the '870 reference is using the term “filamentized” to refer only to separation of the strands from one another so that the strands are no longer clustered together with other strands, and is not using the term “filamentized” to mean separating from each other the filaments used to form each of the strands so that the strands no longer exist, as such, since this reference does not disclose any means to do this. This is in direct contrast to the present invention, where filamentization of the strands means that the strands are reconverted into filaments, and no longer exist as strands.

U.S. Pat. No. 4,600,423 (Method and apparatus for producing a continuous glass filament mat), to Stotler et allies—Owens-Corning Fiberglas Corporation (Toledo, Ohio), discloses that “the second fluid effect zone also increases the filamentization or de-bundling of the strands to provide an even more disbursed or highly filamentized mat of continuous glass filaments having good tensile strength in any direction within the plane of mat.” It can be seen that the '423 reference uses “filamentization” in the same way as the '870 reference—to refer to separation, or debundling, of the strands from one another, not to mean to separate each strand into its individual filaments, thereby eliminating the strands, as is done in the present invention. Of course, in any structure of glassfiber formed by continuous strands, regardless of the degree of their debundling, the filaments are continuous as well, but it does not mean that they are separated from each other. Moreover, it would be impossible to work with “continuous glass filaments”if these really were glassfiber single filaments.

U.S. Pat. No. 7,268,092 to Gerard et Allies—Owens-Corning Fiberglas Technology Inc. (Summit, Ill.) discloses that “reinforcing fiber in the form of filamentized or unfilamentized fiber is then chopped, using a chopper, onto the conductive paste layer.” . . . “In a preferred embodiment the fibers comprise fine filamentized fibers versus coarse bundles of fibers, wherein these fibers flow on top of and with the sheet mo/ding paste from the paste layers under pressure.” Similarly, the '092 patent is talking about fiber strands that are either bundled together, or not bundled together, but in no way discloses the inventive concept of separating the strand of the fiber into its individual filaments, thereby doing away with the strands altogether. Further evidence is provided by the statement “filamentized or unfilamentized fiber is then chopped, using a chopper”, because glassfiber filaments cannot be chopped or handled whatsoever, when isolated.

U.S. Pat. No. 6,268,047 to Mulder—PPG Industries Ohio, Inc.—(Glassfiber mats, and laminates reinforced with the same), textually says: “If desired, at least a portion of the chopped glass fiber strand can be opened up or filamentized, prior to forming the second layer of the mat of the present invention, by a carding machine such as are commercially available from Hollingsworth on Wheels, Inc. of Greenville, S.C. or N. Schlumberger (USA) Inc. of Charlotte, N.C. Preferably, the chopped strand is filamentized by passing the chopped strand through a filamentizing webber system, such as the MODEL B RANDO-WEB® processor system which is commercially available from Rando, Inc. of Macedon, N.Y. See “From Bale to Nonwoven Web in one Continuous Operation”, a publication of Rando, Inc. (September 1990) at pages 4-5, which are hereby incorporated by reference”; pointing out that “As used herein, the term “fibers” means a plurality of individual filaments. The term “strand” as used herein means a multiplicity of fibers grouped together. The term “roving” as used herein means a multiplicity of strands grouped together”.

The '047 patent misnames or confuses the terms “filaments”, “fibers”, “strands”, “roving” and “bundles”, when it asserts “As used herein, the term “fibers” means a plurality of individual filaments. The term “strand” as used herein means a multiplicity of fibers grouped together”.

In fact, the idea that single filaments form “fibers” and that, in turn, these “fibers” form strands is suspicious and inconsistent. By the analysis of FIG. 2a and FIG. 7 and their descriptions, it is clear that what is referred to as strands 20 are not strands but roving, and that what is referred to as “fibers” 22 are not “fibers” but strands.

However, one skilled in the art knows that carding machines are fiber bale-openers, producing nonwoven mats and pads, and that no carding machine is capable to deal with single glassfiber filaments without breaking the glass monofilaments and converting them to powder, as it is clearly displayed in the cited reference's website: www.randomachine.com

According to the disclosure of U.S. Pat. No. '047, the statement: “chopped glass fibers strand can be opened up or filamentized prior to forming the second layer of the mat” means that roving is just de-bundled in strands (not in individual or single filaments) by a carding machine.

### OBJECTS OF THE INVENTION AND SUMMARY OF THE INVENTION

The objects of the present invention includes obtaining, through an improved and further developed technology which overcomes the above mentioned problems and drawback of the prior art, a filamentized FRP putty compound, FRP parts manufactured from said putty mainly by continuous lamination/pultrusion/extrusion and by injection, and devices and methods for manufacturing both the putty and the parts.

### The Composite Putty According to the Invention

The putty of the invention is primarily formed by resin and one or more types of chopped glassfiber reinforcement strands. The fiber reinforcement, whose weight makes up between 10 and 50% of the total weight of the putty, more particularly in the range of 20 to 40%, can be formed by one of the following options:
a) by one or more types of chopped strands that are entirely broken down into monofilaments in the separation step, or
b) by one or more types of chopped strands that are entirely broken down into monofilaments in the separation step in combination with one or more types of chopped strands that are left intact in the separation step.

The very small diameter of the monofilaments, once they are separated, makes them almost impalpable, capable of being substantially colloidally dispersed in the resin, forming a mixture with properties between those of a solution and a fine suspension, providing a putty that is practically homogeneous, isotropic and squeezable, capable of being laminated, extruded, spread, pressed, or injected. The colloidal state of the mixture allows a proper flow behavior, and the ability to be squeezed during molding, and avoids any decantation of the fiber despite its bigger density (2.6 kg/lt) as compared to the resin (1.1 kg/lt).

The chopped strands used in the invention are selected based upon some properties, such as their TEX (meaning how many grams 1 km of strand weighs), the diameter of the monofilaments forming the strands, and their sizing (meaning the coating that holds the monofilaments together as well as ensures proper bonding to the resin matrix). Each one of the types of fibers involved in the same composition can be chopped in one or more lengths, the number of lengths depending on the molding method the putty will be used in, forming a mixture of lengths between 3 and 50 mm, with the bulk preferably being in the range of 12 to 30 mm. There is a relationship between fiber length and strength (longer is stronger), although, for polyester resins, the strength curve is asymptotic at about 25 mm. The fiber composition makes up between 10 and 50%, more particularly in the range of 20 to 40%, of the total weight of the putty, and the percentage of the fiber monofilaments in the fiber composition is an amount necessary and sufficient to isotropically reinforce the resin thoroughly and everywhere in the putty, eliminating irregular shrinkages of the resin causing waves, cellulite texture or orange peel and marks on the surfaces of the parts.

When a glassfiber strand, composed by a plurality of monofilaments, is wet by the resin, this resin penetrates inside the strand, and wets all its monofilaments, whilst the sizing holds them together and prevents the strand volume from increasing. The fiber strand behaves similar to solid timber when it is wet; the water penetrates inside and wets all its fibers, but the volume of the timber practically does not change. On the contrary, when the strand, already soaked by resin, is totally broken down into monofilaments by the high frequency vibration system of the inventive process, these monofilaments are coated with resin, splitting and moving away from each other. The resin encapsulating each monofilament substantially expands the former strand. The reduction of the fiber/resin ratio resulting from this expansion is compensated for because the monofilaments, once separated from one another, fill the plurality of fiber-free spaces that were between the strands because of their shape and interlacing. Moreover, for a given weight of fiber, the thicker the diameter of the monofilaments, the lesser the quantity of resin required to encapsulate them, and the higher the fiber/resin ratio.

In one option, the putty uses two types of roving for further increasing the fiber/resin ratio. For example, mixing the OCV ME4040 or BMC 979 with the OCV SE1200-8800 TEX, a composition is formed in which the two types of fiber complement each other very conveniently. Because of the difference in the monofilaments' diameter measured in microns (about 10 μm for ME4040/BMC979 and 33 μm for SE1200), and the different sizing chemistry, the ME4040/BMC979 strands take longer to breakdown into monofilaments than SE1200 under vibration; vibrating the mixture for the time necessary and sufficient to totally breakdown the SE1200 strands and leaving the ME4040/BMC979 strands intact, it is then possible to have a fiber reinforcement mix in the putty formed, e.g., by 50% of SE1200 monofilaments and 50% ME4040/BMC979 strands.

This arrangement of fibers yields molded parts having high quality surfaces and high mechanical strength, since the 50% that have been broken down into monofilaments may be more than enough or sufficient to provide the colloidal state of the mixture, and to reinforce capillarily the resin, eliminating all the fiber-free resin spaces, whilst the 50% of chopped strands left intact and the lesser quantity of resin required to isolate the SE1200 monofilaments allow higher fiber/resin ratios than the average FRP structures known in the art using chopped strands only.

In another option, the fiber reinforcement of the putty is composed exclusively of monofilaments that are entirely broken down from their original chopped strands. This option yields very translucent parts, offering options to several markets, including decoration, architecture and lighting. The mechanical strength of this option, despite being lower than that achieved by the above mentioned option, is coherent and in line with that of the average FRP structures known in the art using chopped strands only.

The resin composition of the invention comprises a resin that is unsaturated, thermoset, UV and/or chemical catalyst curable (meaning that it can be cured by both UV and chemical curing agents, simultaneously in a mixed curing system or separately), and has the amount of viscosity that is necessary and sufficient to act as a lubricant so as to allow the chopped fibers to slide smoothly relative to one another and to flow when the putty is squeezed during molding. Said viscosity can be obtained by the resin formulation itself and/or by the addition of fillers and/or additives in a preliminary step of the process (offline).

The optional fillers used include calcium carbonate, glass micro spheres and chopped short glassfiber (less than 10 mm), whilst the additives include BYK®-A 555 air release, BYK® W 966 wetting and dispersing, and hydrogenated castor oil spreading agents.

The FRP composite putty, as well as the method and equipment for producing the putty and the method and equipment for molding parts using the putty, provide innovative alternatives to the main systems known in the art for molding plastics, such as SMC/BMC, RTM/INFUSION, Sheets Continuous Lamination and Hand Lay/Spray-Up. The compound's capability of eliminating irregular shrinkages, waves, cellulite texture or orange peel and marks of fiber on the finished part's surfaces provides two smooth “Class A” surfaces, with high dimensional stability and with low cost.

### The Method for Manufacturing the Putty According to the Invention

The method of the invention elaborates and mixes a composition of reinforcement fiber and a composition of resins, both formed as mentioned above, comprising the steps of:
providing a mixing tank having a vibration system and a heat exchanger associated with it, a resin composition, and a composition of reinforcement chopped fiber strands, composed by one or more types of roving chopped to one or more lengths,
placing the resin into the mixing tank, and adjusting the temperature to that needed for the process,
adding the chopped-strands fiber to the resin, and wetting, or soaking, the chopped fiber strands in the resin by natural absorption, avoiding agitation,
starting the vibration system, thereby totally breaking down at least one selected type of chopped fiber strands into monofilaments and capillarily dispersing the monofilaments into the mixture, forming a substantially colloidal putty,
adjusting the composite temperature to room temperature,

wherein each one of the types of fibers involved in the same composition is chopped in one or more lengths, the number of lengths depending on the molding method the putty will be used in, forming a mixture of lengths between 3 and 50 mm, with the bulk preferably being in the range of 12 to 30 mm; the chopped strands are added to the resin until their weight falls in a range from 10 to 50% of the total weight of the putty compound, more particularly in the range of 20 to 40%; the vibration takes place in the mixing tank and generates a necessary and sufficient high frequency vibration to separate, or break down, at least one type of chopped fiber strands, and the breaking down of the selected chopped-strands yields monofilaments having a diameter in a range of 1 to 50 μm, in particular 10 to 35 μm (microns).

### The Equipment for Manufacturing the Putty According to the Invention

The invention also relates to a device for producing the putty compound, comprising a material storage system for storing the resin composition and the chopped fiber strands composition, a metering system for releasing controlled amounts of each of the basic materials from the material storage system, a mixing tank for mixing the materials, a heater/cooler for adjusting the temperature of the mixture, a separation system arranged at the mixing tank, adapted to generate vibrations in the mixing tank to totally and selectively dissociate at least one type of chopped fiber strands into monofilaments and to disperse the monofilaments in the putty, and a system for packing the putty.

### Curing the Putty According to the Invention

Curing the putty can be made by UV radiation with photoinitiators, or by chemical curing, also known in the art as chemical-thermal curing, with chemical curing agents, known in the art as catalysts, promoters, initiators and accelerators, at room temperature or at the high temperature of an oven, or by a mixed curing that is a combination of both. Both UV curing agents and chemical curing agents can be added to the resin either during compounding or during molding parts, with the second option being preferred when a long shelf-life of the putty is needed for marketing or storing it.

One option of the mixed curing of the invention consists of including in the resin composition a proper amount of UV photoinitiators and chemical curing agents, and comprises a first step of quick, partial curing by UV radiation occurring in the production line, followed by a second step of slow and full curing by a room temperature chemical curing process, that manifests, or evidences, itself after the part is removed from the production line and progresses during the storage of the finished part until the complete polymerization of the resin.

This system adds the advantages of both chemical catalyst curing and UV curing, i.e. low cost and high operational speed and high quality. In mixed curing, the quantity of photoinitiators is the amount necessary and sufficient for partially hardening the putty, allowing its handling on the production line, while the quantity of chemical curing agents is the amount necessary and sufficient to conciliate two antagonistic situations, that is, creating a sufficient pot-life for processing the putty without increasing the resin viscosity in the production line, and at the same time, assuring the full polymerization of the resin after the part has been removed from the production line. In addition to other environmental benefits, the mixed curing also prevents styrene emission, since the UV starts curing the laminate from the surface to the inside, so the cured surface blocks styrene emissions during the following slow chemical catalyst curing step.

In this option of mixed curing system of the invention, the second step of slow chemical curing can be aided or sped up by post curing the putty with one or more UV expositions or a sequence of UV expositions. Optionally, said second step of chemical curing can be entirely replaced by said UV post curing made of one or more UV expositions, occurring offline, avoiding the use of chemical curing agents.

Although UV radiation is the preferable radiation system, other radiation systems such as electron beam, ultrasonic and others, compatible with the process, can also be used.

### Parts Made from the Putty According to the Invention—a Continuous Laminate Made by Pultrusion/Extrusion

Parts made from the FRP putty of the invention include a continuously produced laminate, which offers new alternatives to the market, by providing one or more of the following benefits:
planar, smooth and even surfaces due to the substantial homogeneity and isotropy of the putty, free of the typical FRP crisp cellulite texture or orange peel, waves and of marks that occurs when using chopped fiber strands,
straight and smooth extruded longitudinal edges with no sharp or fibrous corners, such as those formed when a conventional FRP laminate is cut by tools, enabling uniform joints to be composed with adjacent laminates without the need for installation of molding strips to cover the joint between them, and avoiding entrance into the laminate of dirt and bacteria through the rough edges,
higher fiber/resin ratio and higher mechanical strength as compared to the conventional FRP structures made of chopped strands only,
feasibility of mass production, which translates in low cost per m².

One example of the laminate of the invention is a plain laminate, either flat or corrugated (meaning having longitudinal uniform grooves), having the main features indicated above, consisting of a continuous strip of putty, but having no films linked to the sides of the FRP core; the laminate is molded and cured as described below.

Another example of the laminate of the invention has a lower film having a first ink that is chemically bound to an upper face thereof; a putty core layer having a lower face that is lying on the first ink, with the resin in the putty core being chemically bonded to the first ink; an upper film having a lower side to which a second ink is chemically bound, the second ink being chemically bound to the resin in the putty core layer as well; whereby the lower film, first ink, putty core, second ink and upper film are fused to compose a laminate forming a unitary body. The inks can be either transparent or pigmented so as to form images, text or design, providing, respectively, interesting and innovative applications for anticorrosion protective systems and for architecture, decoration, signs and media; the printing upper and lower films further increasing the resistance and washability of the surfaces using solvents. In addition, films provide an impermeable liner when the FRP laminate is used in contact with aggressive chemicals and solvents.

Another example of the invention provides a laminate, as above, where one or both of the upper and lower films are formed by multifunctional film system including films for linking and finishing, where all these films are capable of being printed upon; the linking film layers being chemically bonded to the putty core and the finishing/protection film layers forming the surfaces of the laminate and having sufficient resistance to protect the laminate from scratches, cuts, and impacts, as well as chemical attacks thereto; where all films are bound to each other by one or more resins selected from a group consisting of inks and intervening adhesive resins, and each of the multifunctional film systems can optionally be composed by a single polyvalent film layer adapted to be capable of linking, printing and finishing/protection. Moreover, said multifunctional film system can be formed by bonding together films made from different materials, such as different types of plastic, metal foil, paper, textiles, ceramic, carbon, and other compositions, compatible with the methods of the invention, and capable of fulfilling particular applications.

A further example of the invention provides a laminate wherein a decoration is made by silk-screening onto an exposed face of said FRP putty core, using a serigraphic ink made of unsaturated polyester ink, which is crosslinked to the putty core, as will be described below, providing a unique scratch-resistant and solvent-washable decoration.

Yet a further example of the invention provides a laminate as described in any of the examples above, wherein one or both longitudinal edges are bent such that they each form an angle of less of 180 degrees with the plane containing the central area of the laminate, thereby creating longitudinally extending corners at the bends formed where the central area and each of the longitudinal edges meet.

### The Method for Manufacturing a Laminate According to the Invention

The present invention also relates to a method of manufacturing a FRP laminate on a continuous production line. The method is based on an innovative technique combining a spreader and a pultrusion system for molding the putty. The putty is fed into the production line through a feeding system, preferably composed of a screw pump or a pressurized tank, a metering-synchronizing gadget and a spreading setup, which form the putty into a gauged layer having a predetermined width and thickness. The putty is encapsulated between films and hauled by a driving group, preferably comprising cylinders, through a pultrusion system where it acquires a final width and thickness, becoming a continuous strip of laminated putty, and is cured.

The feeding, metering and spreading system that forms the gauged putty layer onto the lower carrier film in the production line synchronized with the driving system that hauls the laminate throughout the line, assuring the flow (m³/min) of putty supplied is coherent with the volume (m³/min) of the continuously produced laminate will henceforth be referred to as “spreader”, whilst the gauged layer of putty formed onto a lower release carrier film, preferably being slightly narrower and slightly thicker than the final cross-section of the finished laminate, so as to allow the layer to be thinned and expanded (meaning that the layer is laminated), under the pressure of a spatula in the pultrusion step will henceforth be referred to as “putty layer”.

The laminate of the invention is shaped directly to the final width, dispensing with the need for longitudinal cutting of the lateral edges, thus eliminating the waste of material that would otherwise be trimmed from the laminate's sides, thereby greatly improving the economy of the product and of the production machinery, further simplifying the production process and not showing the typical rough look of edges created when a laminate is cut by tool. Moreover, this fact has an important beneficial impact on the environment, since there is currently no known environmentally friendly way of disposing of this waste.

When glassfiber is unwound, conveyed, chopped and sprinkled onto the machine in the production line, as is done in the prior art machines, dry glassfiber very fine particles are released and float up and hover in suspension in the air, providing a hazardous working environment for the workers, and being ecologically undesirable. The current invention premixes the glassfiber with the resin off-line, so that when the putty is deposited onto the machine in the production line, no glassfiber is free to move into suspension in the air.

One example of the method of manufacturing the laminate of the invention includes the steps of:
feeding a lower releasing film onto a platform at a first end of a continuous production line;
spreading a layer of putty such that it covers the exposed surface of the lower film, with the putty constituting a FRP core of the laminate;
feeding an upper releasing film onto the exposed, upwardly-facing surface of the putty, whereby the putty is encapsulated between the lower film and the upper film, with the lower film, the putty core, and the upper film together forming a continuous strip of laminate;
pultrusion of the strip by means of a consolidating system having a lower flat platform, a spatula and a number of lateral walls for shaping the putty to a final thickness and width, shaping also the edges,
curing the laminate as it moves along/through one or more molds to shape the main transverse section so that it is either flat or grooved, as well as to bend its lateral edges into wings, if so desired;
cutting the laminate to a desired length, producing a laminate that is either flat or grooved.

The lower and upper releasing films are used in this case merely as process films, which in addition serve as light protection for the laminate during storage and shipping, and are removed by the end user prior to installation of the laminate.

Another example of the method of manufacturing the laminate of the invention includes:
providing a lower film having an upper side which has been preprinted with a first ink that is chemically bound to the upper side of the lower film to form a composite therewith, the composite having a lower side and an upper side;
feeding the preprinted lower film onto a platform at a first end of a continuous production line so that the lower side of the composite faces downwardly and travels on the platform, with the upper side of the composite facing upwardly to present an exposed surface;
spreading a layer of putty having a predetermined width and thickness such that it covers the exposed surface of the composite, with the putty constituting, when the laminate is completed, a fiber reinforced plastic (FRP) structural core of the laminate;
feeding an upper film having a lower side that is preprinted with a second ink that is chemically bound to the lower side of the upper film, the upper film being dispensed onto the exposed, upwardly-facing surface of the putty such that the pre-printed lower side of the upper film contacts the exposed, upwardly-facing surface of the putty, whereby the putty is encapsulated between the lower film and the upper film, with the lower film, the putty core, and the upper film together forming a strip of putty having a lower face, an upper face, and first and second longitudinal edges;
pultrusion of the strip by means of a consolidating system having a lower flat platform, a spatula and a number of lateral walls for shaping the putty core to the desired thickness, width, edges and surface finish,
curing the laminate as it moves along/through one or more molds to shape the main transverse section so that it is either flat or grooved, as well as to bend its lateral edges into wings, if so desired; and
cutting the continuous strip to form a laminate of a desired length.

The step of supplying the upper and lower films comprises the option of supplying one or both of them in the form of a multifunctional film system including films for linking and for finishing, where all these films are capable of being printed upon; the linking film layers being chemically bonded to the putty core and the finishing film layers forming the outside of the laminate and having sufficient resistance to protect the laminate from scratches, cuts, and impacts thereto; where all films are bound to each other by one or more resins selected from a group consisting of ink and an intervening adhesive resin, and each of the multi-functional film systems can be optionally formed by a single polyvalent film layer capable of linking, printing and finishing.

Another example of the method of manufacturing further comprises silk-screening at least one side of the plain laminate with a serigraphic ink, soon after the laminate is removed from the production line and only partially cured. When this serigraphic ink is made of unsaturated polyester resin, there occurs a process wherein both the serigraphic unsaturated polyester resin ink to be applied and the laminate to which it is applied are cured by a mixed curing system combining UV curing and chemical curing, comprising two steps: in a first step, a partial UV curing of the ink, such that an exposed, outer surface of the ink layer cures sufficiently to form a skin that allows it to be handled, while leaving an inner, unexposed portion of the ink layer, that is in contact with the FRP core, sufficiently pasty and moist so as to allow it to chemically attack the substrate; subsequently allowing the applied ink and the resin of the substrate to fuse to each other by cross-linking during a second curing step by chemical curing, and allowing both to fully cure, forming a unitary body.

### The Device for Continuously Manufacturing a Laminate According to the Invention

The present invention further relates to a device for manufacturing the laminate of the invention on a continuous production system, the device having a structure comprising a platform and a driving system for hauling the laminate along the platform, further comprising a FRP supplying system including a spreader set for forming a gauged layer of the putty material onto a lower film that travels along a platform of the device, with an upper film laying upon the putty layer so as to encapsulate it between both films; a funneling or pultrusion system for shaping the putty layer to a final width and thickness, curing stations for curing the laminate as it travels along a profiling system including one or more molds that can be either a zigzag mold, or crossbars setup, (for stretching and creating flat laminates), or a grooving mold (for creating grooved laminates), each of these molds being usable alone or in combination with a mold for bending the longitudinal edges of the laminates to create wings.

In one example, the groups of the above-mentioned device are detailed as follows:
the platform has a longitudinal axis;
the driving system comprises cylinders located at a terminal end of the structure for continually hauling the laminate along the platform and through the device, the driving system being capable of hauling the laminate at a range of operational speeds;
the lower and upper films for conveying and encapsulating the putty composition are respectively dispensed from a lower and an upper feeding reel system, both provided with a built-in brake, for continuously supplying at least one lower and at least one upper film onto the platform;
the FRP putty supplying system comprises at least one tank, preferably pressurized, at least one valve, and at least one spreader set for forming a layer having a predetermined width and thickness of putty onto said at least one lower film;
the pultrusion system for shaping the putty layer to a final width and thickness, and consolidating the lower film, the putty compound core and the upper film such that they form a continuous strip of laminate; the pultrusion system comprises a rigid inclined spatula, a number of pairs of lateral walls and a lower flat surface on which the lower film travels;
the profiling system comprises one or more molds for stretching or shaping the transverse profile of the laminate, respectively for flat or grooved laminates, optionally in combination with a mold for bending the longitudinally edges of the laminate;
the curing stations can operate either by “mixed” curing combining a quick, partial curing by UV radiation on the production line and a slow, full curing by a room temperature chemical curing, made by chemical curing agents, once the laminate has been removed from the production line, or by a quick full UV curing only, occurring entirely on the production line; and
the cutting system for separating a completed laminate includes any tooling capable of cutting.

In another example, the device is similar to the above example except that one or both films are recirculation films and it includes additional guiding cylinders or skates for supporting and guiding one or both of the films in the form of endless loops of recirculation films acting as conveyor belts. These films are recirculated release films, and they work as endless loops of release films or endless conveyor belts, guided by cylinders for supporting and guiding the endless loops of recirculated films.

Optionally, when a high quality is not required in the laminate and the project and application allows flexible dimensional tolerances, the device can be simplified adapting the spreader (56) for acting as an extrusion system for forming a gauged layer of putty (15) onto the lower carrier film (1), the putty layer being cured by the same curing system described above. The pultrusion system (6a, 6b, 6c) and all the upper structure of the device can be omitted. The laminate produced therefrom has only one finished side and the system is not as eco-friendly as the option above.

One of the most impressive advantages of the technology of the invention is the size of the device. Compared to the prior art discussed above, it is so short that it makes everything easy, even the packaging for delivery or export. Although the equipment of the invention can have any width, it can be pointed out that, most of the time, wide laminates (e.g. 3 m) can be replaced with smaller modular laminates (e.g. 1 m) as long as the smaller laminates have straight, smooth and perfectly fitting edges, as occurs with the laminates of the invention, with lower cost/m2 and easier production, handling, transport and installation than is possible with wider laminates. The working area required for the machine according to the invention is much smaller than that required for prior art machines; moreover, the shorter is the machine, the higher is the quality of the laminate and the shorter is the cycle time. In addition, a small machine minimizes energy consumption and pollution generated. On average, the laminating device of the invention needs as little as 2 m length and allows for speeds up to 20 m/min, depending on the type, quantity and setup of UV sources used.

The cost of the machinery of the invention is very low as compared to the machinery known in the prior art. On average, a machine according to the invention can cost as little as 30,000 USD instead of the 450,000 USD of the known machines in the market, for a 1 m width laminate basis. Moreover, the best way to deal with scrap is not to generate scrap, and the innovative device of the invention allows the production of scrap-free laminates by manufacturing the laminates directly to the final width, eliminating the need to trim the edges. No edge trimming means zero scrap.

### Injection Molded Parts Made from the Putty According to the Invention

Injection molded parts made from the putty of the invention are strong, light, have a high quality appearance and producible under low-cost.

They match most of the technical features of important closed-mold FRP processes known in the art, such as SMC, BMC, RTM, LRTM, and INFUSION, with the difference of having a very much lower cost. In fact injection molded parts made from the putty of the invention have excellent dimensional stability, good complex shape producibility, low labor needed, feasibility of mass production, high percentage of fiber, two “class A” surfaces, low cost tooling and short lead time, allowability of manufacture of parts of any size and thickness, no need for the expensive fiber reinforcement preforms, no need for a gelcoat, no VOC (volatile organic Compound), and no finishing operations required. If compared to open-molding systems such as HANDLAY/SPRAY UP, one skilled in the art understands that the advantages of the invention are enormous.

Thermoplastic injection parts are the larger volume of plastic parts produced worldwide, with such parts coming in a wide variety, and varying greatly in their size, complexity, and applications. The filamentized fiber reinforced putty of the invention allows for the manufacture of FRP injected parts matching most of the features of thermoplastic injection parts, with the difference of having a very much higher mechanical strength that the thermoplastic injection parts, or in other words, for a given strength, parts made from the FRP putty of the invention can be thinner, lighter, and more economical than comparable thermoplastic injection parts.

The injection molding parts of the invention include glassfiber single filaments that are typically 25 mm long, about 10-30 microns thick, and typically make up 20-40% content of the part by weight. The use of glassfiber monofilaments makes the fiber not to show on the surfaces of the part, and the putty itself behaves as a super reinforced gelcoat. The parts are dimensionally stable and warp-free, the surfaces are smooth, free of waves, cellulite texture or orange peel thanks to the uniform fiber density and the homogeneity of the composite, with good abrasion and weathering resistance. The injection of parts using the putty of the invention suggests a renewal for the market of plastic parts, especially for engineering plastic parts, where the compromise between strength, quality of the surfaces and cost is the crucial factor in a globalized economy.

### Device for Manufacturing Parts Made from the Putty According to the Invention

Injection molding using the putty of the invention doesn't require complex equipment, but instead requires only a portable electric-driven screw-pump for injecting the putty between two clamped mold halves. Although the putty injection process can be, in some cases, slower than the more expensive and sophisticated conventional ones for injecting thermoplastics, the very low cost of the molds for injection of the FRP putty allows for multiple units to be made and used, economically, at the same time, thereby making up productivity. Molds may be made of any material, including reinforced plastic or vacuum-formed transparent thermoplastics, self-releasing or chemically compatible with the resin of the putty, e.g. PETG, with a relatively light structure as a result of the low pressure needed for squeezing the putty into the cavity of the molds. Optionally, the same mold used in injection molding can be used as a compression mold.

### Method for Manufacturing Parts Made from the Putty According to the Invention

The putty of the invention makes the injection molding process simple, economical, clean and safe. The process requires, basically, a light two-part mold and a pump, or a pressurized tank. The pump may include a valve for mixing additives, curing agents or processing aids to the putty. The injection molding can be vacuum assisted, gaining speed and efficiency.

The molding operation requires very low manpower and low investment, both in compounding and molding, which translates into lower manufacturing costs as compared to most FRP systems known in the art, and the use of the putty reinforced with high loading of long glassfiber allows the injection method of the invention to produce stronger, thinner and lighter parts as compared to parts made by conventional thermoplastic injection systems.

The injection method can use several curing systems; in the case of using either mixed UV/chemical curing or full UV curing, there is no generation of scrap or waste resulting from the injection step; any putty leftover during the step of injection can be collected and reused, since it is still uncured; the resins used are standard resins, with curing agents and additives added thereto. In the case of being fully cured by UV curing only, parts made of catalyst-free putty can be recycled and reused as filler in other virgin material, without interfering with the curing of the new material.

In the case of being cured by chemical curing only, parts can be sufficiently cured in their molds until reaching their handling and release hardness. The low cost of the molds allows for having multiple units in use, and productivity is greatly favored by the fact that there is no need for finishing operations. The parts will reach full cure during storage.

Moreover, the injection process of the invention is environmentally friendly, having no styrene emission, no waste or scrap generation, no fiber particles hovering in the air, and no requirements for finishing operations, assuring a clean, healthy work environment.

The putty injection molding of the invention allows for FRP to be competitive in markets that are far larger than the composites market itself, markets that are traditionally and exclusively held by other materials such as thermoplastics and metals.

### BRIEF DESCRIPTION OF THE DRAWINGS

In the following, the invention is described based on embodiments shown in different schematic views. In particular, it is shown in:

FIG. 1 a side view of the lamination/pultrusion/extrusion device of the invention compared to the side view of a prior art machine, in the same dimensional scale;

FIG. 2 a side view of one example of the device of the invention including endless loops of release films, setup for manufacturing a flat, plain laminate;

FIG. 2a a side view of the device of FIG. 2, modified to simplify the structure and produce a lower quality laminate.

FIG. 3 a side view of another example of the of the device of the invention, setup for manufacturing flat laminates;

FIG. 3a a side view of another example of the device of the invention setup for manufacturing flat laminates with bent edges;

FIG. 3b a cross-section of a portion of a mold for creating bent edges in the laminate;

FIG. 4 a side view of another example of the device of the invention setup for manufacturing grooved or corrugated laminates;

FIG. 4a a cross-section of a mold for creating a corrugated or grooved laminate with bent edges;

FIG. 5 a side view of an example of the pultrusion system for shaping the laminate;

FIG. 6 a perspective view of the pultrusion system of FIG. 5;

FIG. 7 a cross section of an end of a laminate having bent edge or wing;

FIG. 8 a cross section of an end of a laminate with no bent edge or wing, and having a longitudinal edge that has been cut by a tool;

FIG. 9 a cross section of one example of a plain laminate;

FIG. 10 a cross section of one example of a decorated laminate;

FIG. 11 a cross section of another example of a decorated laminate;

FIG. 12 a cross section of another example of a laminate, showing silk-screening on the laminate that has been only partially cured;

FIG. 13 a cross section of the example of a laminate shown in FIG. 12, with the laminate being fully cured;

FIG. 14 a view of an example for preparing the putty of the invention;

FIG. 15 typical spread-out, or mat, of dry glassfiber chopped strands;

FIG. 16 layout of a mix of two types of chopped strands;

FIG. 17 a theoretical layout of some glassfiber chopped strands before their breaking down;

FIG. 18 monofilaments after their separation from the chopped strands of FIG. 17;

FIG. 19 the wet-out of the fiber by the resin in the mixing tank;

FIG. 20 effect of vibration in the separation of the monofilaments;

FIG. 21 shows an example of how the putty is molded by injection.

### DETAILED DESCRIPTION OF THE DRAWINGS

The components of the technology according to one or more embodiments of the present invention will be clearly understood from the following description of the schematic figures, which contains the same numeric references used in the drawings. Some figures have been intentionally drafted off scale for better clarity, where some obvious parts of the equipment have been intentionally omitted for better clarity. In particular, these parts being structure that supports the elements that are shown.

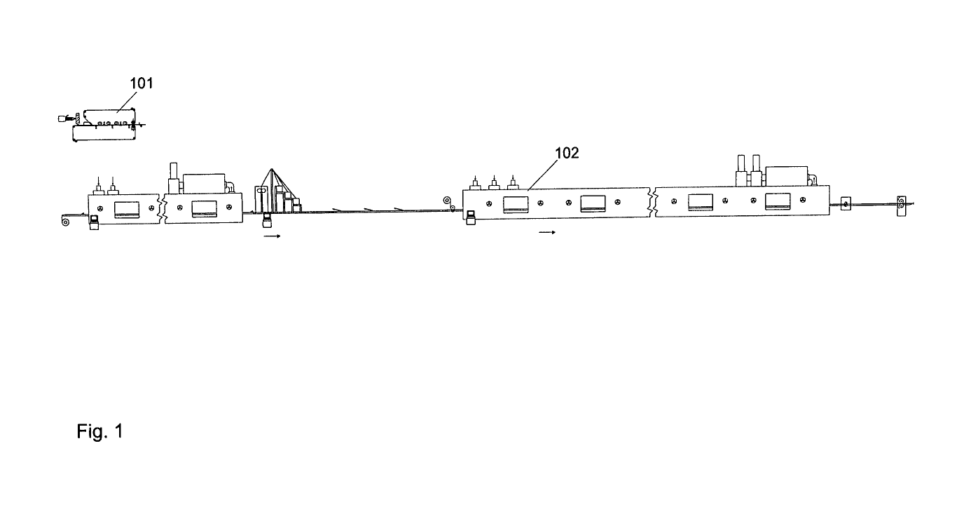

FIG. 1 shows in side view a dimensional comparison between the machine of the invention (101) and a machine having technology known in the art (102), so as to make evident the huge difference in size, logistics, complexity, crew and investment of both technological conceptions.

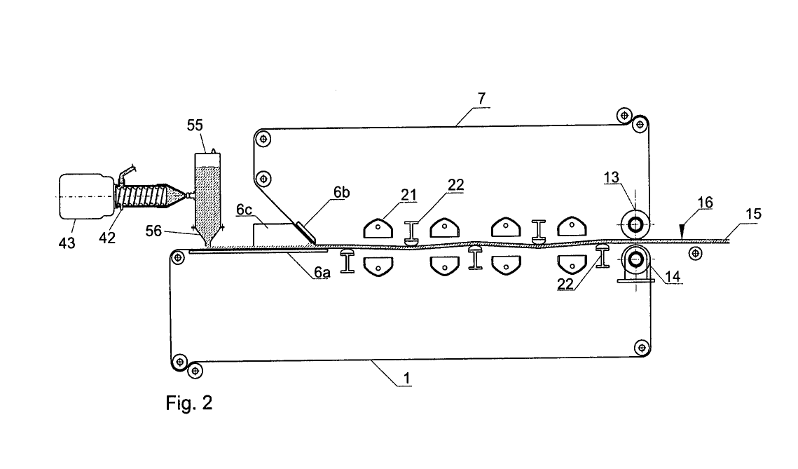

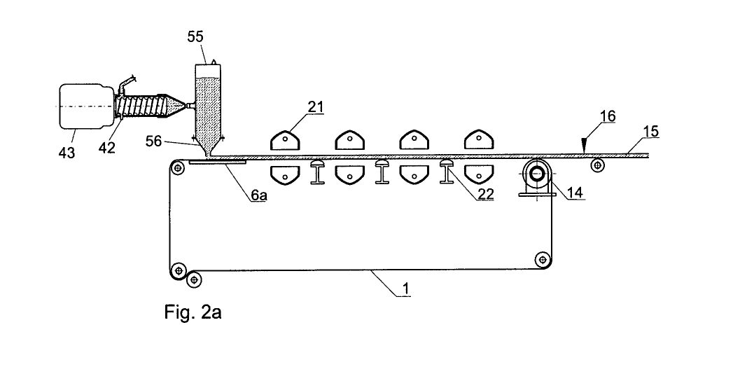

FIG. 2 shows a side view of an example of the device of the invention for producing plain flat laminates. The machinery comprises:
a lower conveyor belt release film (1) moving onto the platform of the machine and conveying all components of the laminate being produced;
a system for feeding the putty (15) comprising a screw pump (43), including a valve (42) for injecting additives, alternative curing agents and processing aids, a tank (55) for equalizing the feeding pressure of the putty, and a spreader (56) for forming a gauged layer of putty onto the lower release film (1);
an upper conveyor belt release film (7) moves along the layer of putty, thereby encapsulating the putty between the lower and upper release films and forming a continuous strip of putty, the ensemble being hauled through a pultrusion system (6a, 6b, 6c) comprising the flat platform (6a), the spatula (6b) and one or more pairs of lateral walls (6c) for shaping the putty strip to its final width, thickness and edges, forming a plain laminate;
a zigzag mold (22) stretches the laminate while the UV curing station with UV sources or lamps (21) cures the laminate, assuring its flatness, such UV sources (21) being positioned above and/or below the laminate and setup such that they can be static or movable so as to scan the laminate; a first set of UV sources (21) can be positioned next to the spatula (6b) so as to provide an initial radiation on the putty exactly where and when it is being shaped in the pultrusion system (6a, 6b, 6c), giving to the putty strip the sufficient consistency to maintain the same shape during the subsequent phases of the continuous process (meaning that the putty is “frozen” at the exit of the pultrusion);
a driving system of cylinders (13, 14) hauls the laminate through the device;
a transverse cutting system (16) severs the laminate when the desired length or roll of laminate has been produced.

FIG. 2a shows a side view of the device of FIG. 2 where the spreader (56) is adapted to perform the extrusion of the putty, forming a gauged layer of putty (15) onto the lower conveyor belt releasing film (1), thereby eliminating the need for the pultrusion system (6a, 6b, 6c) and the upper conveyor belt release film (7). The laminate is cured by same curing system of FIG. 2 and forms a plain laminate having less quality and capability than that produced by the device of FIG. 2.

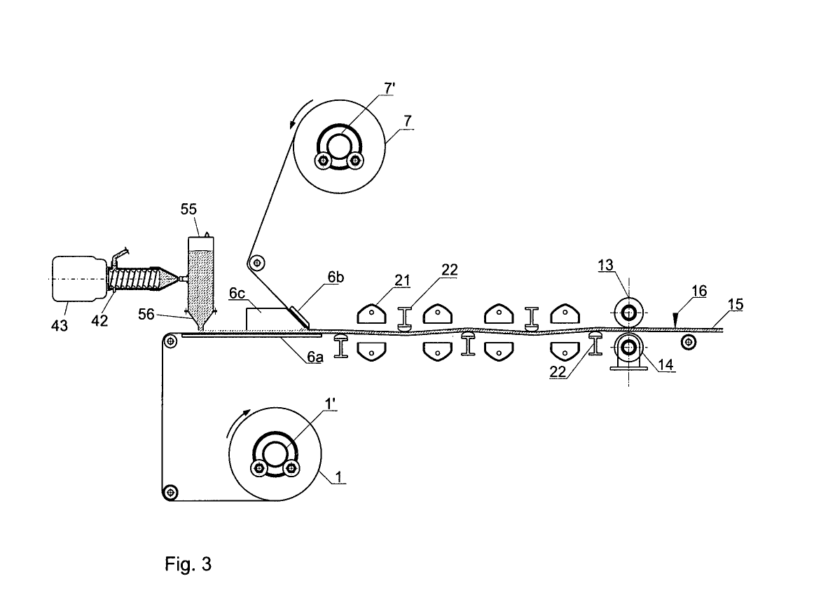

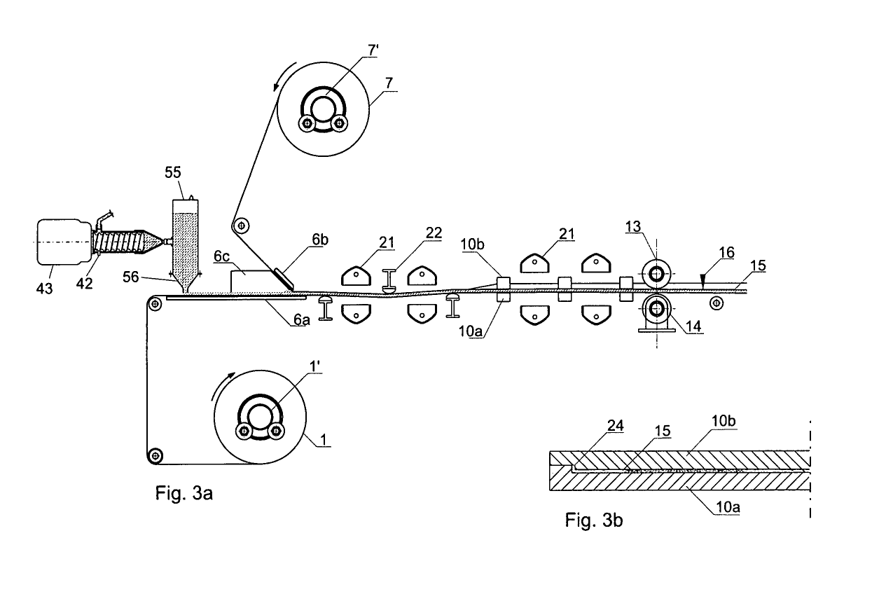

FIG. 3 shows a side view of other example of the device of the invention for producing either plain or inked/decorated flat laminates. The device is similar to the device of FIG. 2, except that it includes a lower film feeding system (1′) including built-in brakes for controlling of the tension of feeding a lower film that may either be a release film (1) or an inked film (1, 25) or (1b, 25-26, 1a, 25) onto the platform of the machine and an upper film feeding system (7′) including built-in brakes for controlling of the tension of feeding an upper film that may either be a release film (7) or an inked film (7, 25) or (7b, 25-26, 7a, 25) onto the layer of putty (15), thereby encapsulating the putty between the lower and upper films. The films are either lightly adhered to the putty core and must be removed by the end user before installation of the laminate, if the films are release films, or if the films are in the form of inked films, then the films are permanently incorporated to the putty core for forming an inked or a decorated laminate (1, 25, 15, 25, 7) or (1b, 25-26,1a, 25, 15, 25, 7a, 25-26, 7b).

FIG. 3a shows a side view of one example of the device of the invention for producing decorated flat laminates. The device is similar to the machine of FIG. 3, except that it includes one or more two part molds (10a, 10b) for bending the longitudinal edges (24) of the laminate to form wings at an angle of less than 180 degrees with a central portion of the laminate, thereby creating longitudinally extending corners at the bends where opposite edges of said central area and each of said longitudinal edges (24) meet. When the longitudinal edges of a flat panel are to be bent, then the UV curing takes place in two stages. The first stage occurs as the laminate passes through the zigzag mold (22), when the laminate is exposed to enough UV light at the first UV curing station (21) to cause the entire width of the laminate to obtain a flexible, rubbery consistency and assure the flatness of the laminate. The second stage of UV curing takes place at a second UV curing station (21) once the longitudinal edges (24) of the flexible, rubbery laminate are bent by molds (10a, 10b).

FIG. 3b is a cross section showing an example of one end of a two-part mold (10a-10b) used when a flat laminate with bent wings at the longitudinal edges (24) is produced.

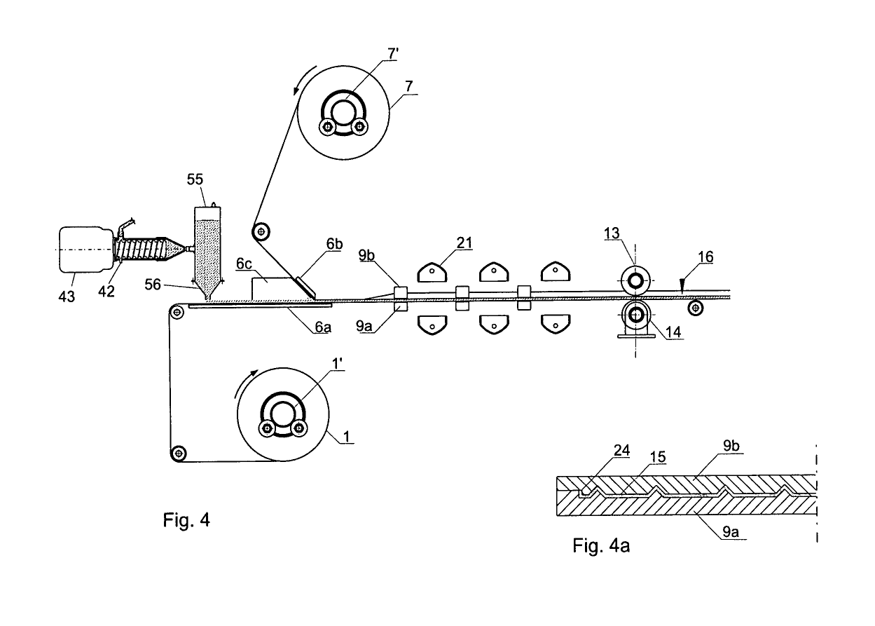

FIG. 4 shows a view similar to FIG. 3, but for an alternative example designed to produce a grooved laminate. Instead of zigzag mold (22), this example includes a number of two-part grooving molds (9a, 9b), but all other features remain as described above for the example of FIGS. 2 and 3, and FIG. 4a is a cross section showing an example of two-part molds for grooving (9a-9b), used when a grooved and winged laminate is produced.

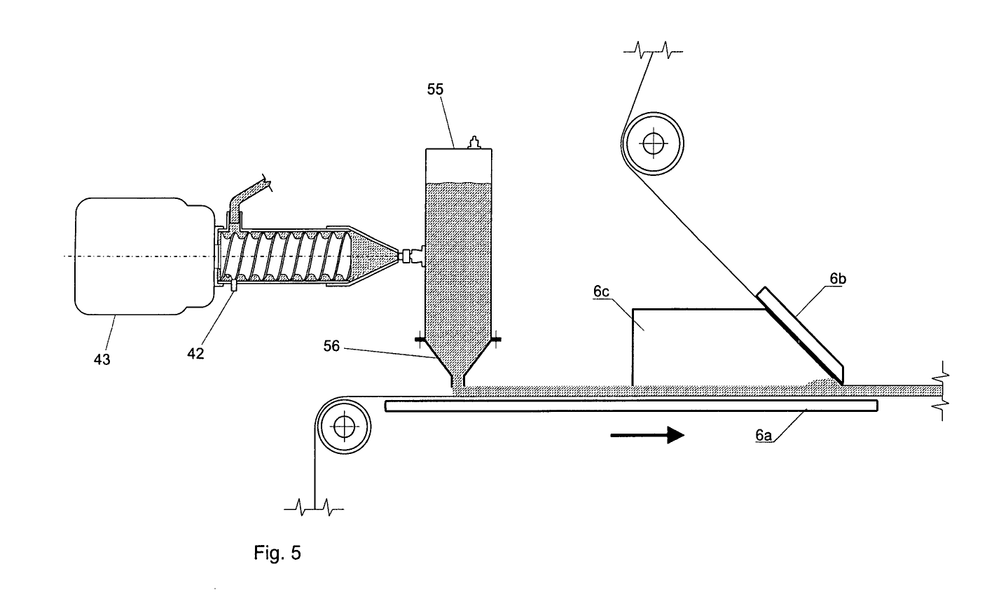

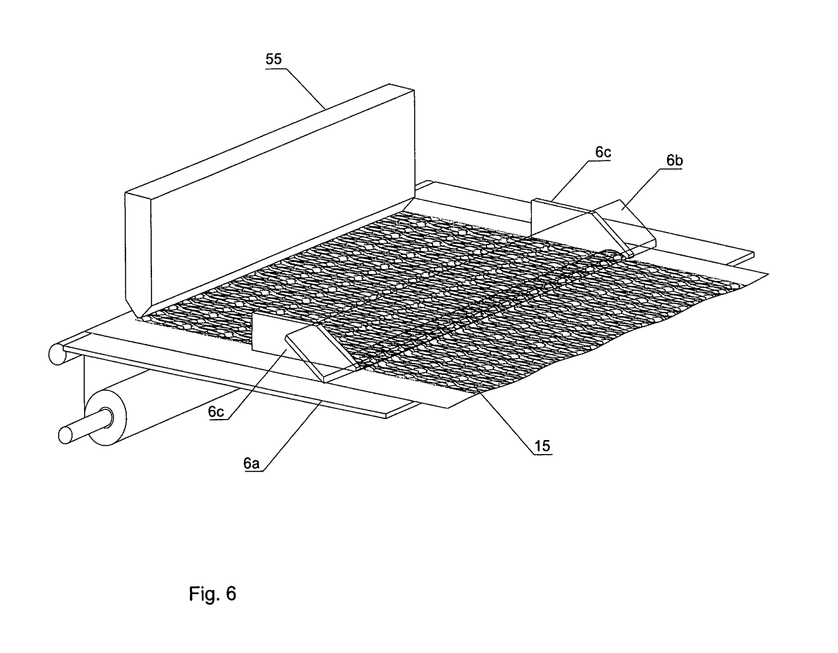

FIGS. 5 and 6 show an example of how the thickness, width and edges of the laminate are shaped in the pultrusion system, comprising spatula (6b), lateral walls (6c), and flat platform (6a), where the spatula (6b) has been intentionally made of glass so as to be shown in transparency.

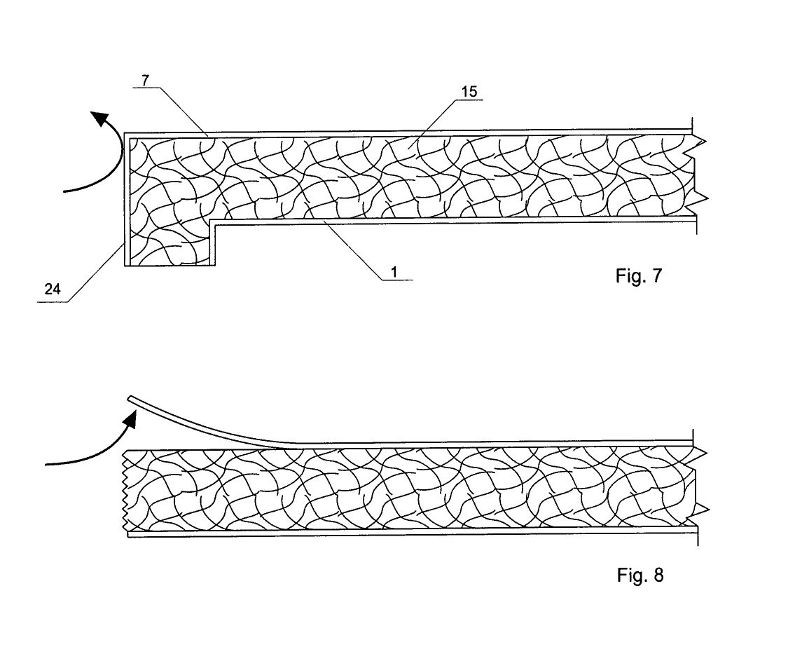

FIG. 7 shows a cross section of one end of a laminate having the core (15) incorporating films (1, 7), and showing the longitudinal edge (24) of the putty core (15) which has been bent to form a wing at an angle of less than 180 degrees with the central area of said laminate, thereby creating longitudinally extending corners at the bends where opposite edges of said central area and each of said longitudinal wings (24) meet as described above, whilst FIG. 8 shows the laminate of FIG. 7 with no bent wing, suggesting the different performance of both laminates when hit by lateral impacts represented by the dark arrows in the figure. The rippled surface on the edge of the laminate in FIG. 8 represents the fibrous surface obtained when cutting the FRP laminate produced with conventional glassfiber strands by conventional systems, as is done in the prior art. As can be seen by comparing FIGS. 7 and 8, a lateral impact to the laminate with bent edges or wings (24) tends to be withstood without any negative effect on the laminate, because the impact hits a finished surface protected by upper film (7), whereas a lateral impact to the laminate with no wing can cause delaminating and chipping.

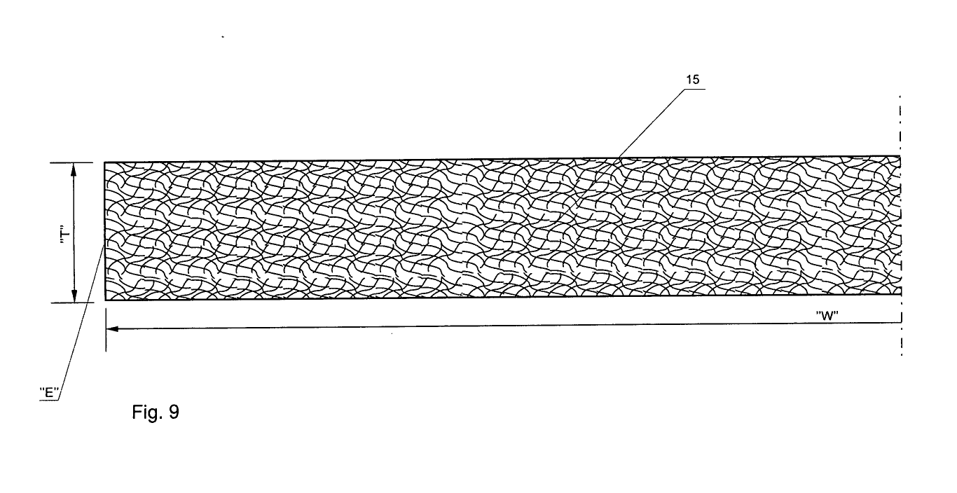

FIG. 9 shows a cross-section of the continuous strip of a plain laminate, that may be either flat or grooved, made using the filamentized putty of the invention and release films (1, 7) that have been removed, wherein “W” is the width and “T” is the thickness of the laminate. The FRP putty of the invention, when cured, provides naturally and with no additional operations, even, smooth and finished surfaces, including the thin strip of the surface “E” of the longitudinal edges. Although the dispersion of the fibers in the putty is isotropic, the long fibers near the edges orient themselves parallel to the moving direction of the putty strip under the action of the pultrusion molding system of the invention, in particular by the brushing of the lateral walls (6c) upon the surfaces “E” of the edges; further to provide a perfect finishing of the edges, the unidirectional orientation of the fibers along the edges improves their impact strength as compared to the spiky edges obtained by prior art systems.

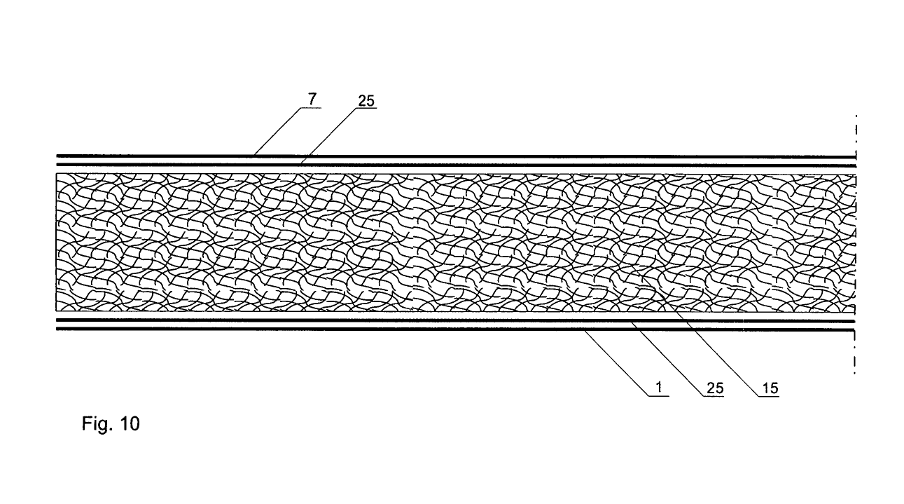

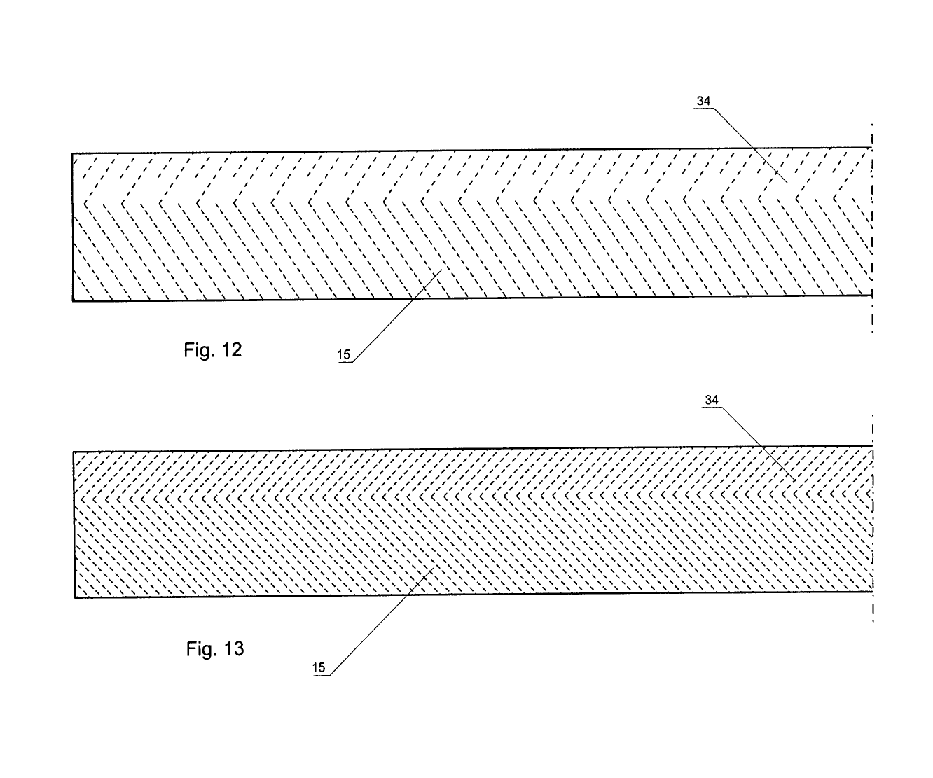

FIG. 10 shows a cross-section of the continuous strip of a plain laminate that comprises a double-faced decorated laminate. The laminate can have images, text, or design visible on each of a lower face of the laminate and an upper face of the laminate. Starting from the lower face of the laminate, this example comprises a lower film (1), at least one layer of ink (25), a putty core (15), at least one layer of ink (25), and an upper film (7). The ink serves to permanently bond the respective films (1, 7) to the putty core (15). If one wanted to make the laminate of the example of FIG. 10 to be a one-faced laminate, all the layers above or below the putty core (15) could simply be omitted. Similarly, if it were preferred, one could produce images using an unsaturated polyester serigraphic ink (34) to silk screen a design on the side of the FRP core of FIGS. 9 and 10, as will be discussed below with respect to FIGS. 12 and 13.

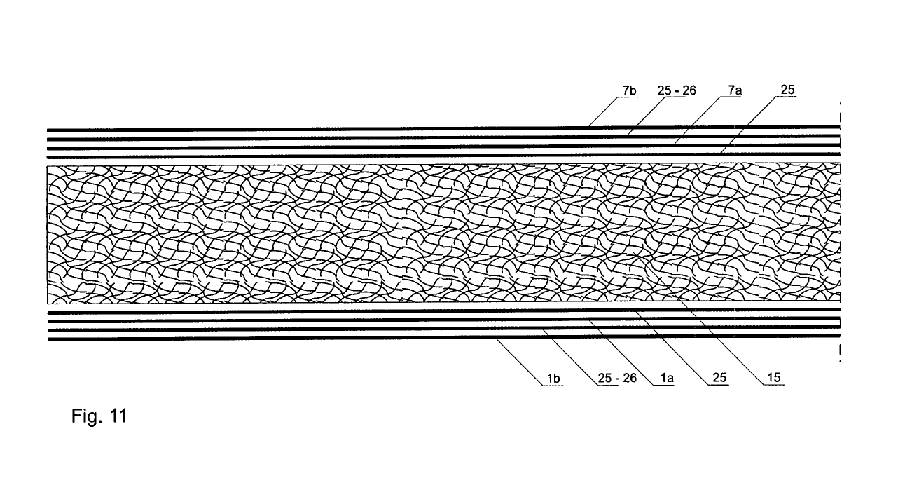

FIG. 11 shows a cross-section of the continuous strip of laminate that can have images, text or design visible on one or both faces of the laminate. Starting from the lower side of the figure, this example comprises a finishing film (1b), at least one layer of ink (25) or adhesive resin (26), a linking film (1a), ink (25), putty core (15), ink (25), a linking film (7a), at least one layer of ink (25) or adhesive resin (26), and finally, a finishing film (7b). Each of these layers will be discussed in more detail below. The combination of films and intervening ink and/or adhesive resin (1b, 25 or 26, 1a) or (7b, 25 or 26, 7a) are bound to each other and create a multi-functional film system, this multi-functional film system optionally being replaced by a single polyvalent film layer properly adapted for linking, finishing and printing. While the laminate of FIG. 11 can have images visible when looking at either the front or the back side of the laminate, if only a one-faced laminate with an image only visible on the front side of the laminate were desired, then all of the printed layers positioned either above or below the core (15) could be omitted, resulting in a laminate composed only of finishing film (1b or 7b), at least one layer of ink (25), a layer of adhesive resin (26), linking film (1a or 7a), ink (25), and core (15). If, instead of using the adhesive resin (26) to physically bond the ink (25) on the inner, inked side of the finishing film (1b, 7b), respectively, to the outer side of the linking film (1a, 7a), the bonding were a chemical fusion bond by virtue of another ink (25) cross-linking with the outer surface of the linking film (1a, 7a), both previously treated, then the layer of adhesive resin (26) could be omitted from this example. In all cases, it is a matter of choice as to which ones of the inks (25) would be pigmented and which ones would be transparent.

According to a further example, at least one of films (1a, 1b, 7a, 7b) can be a white opaque film or a film colored in any color.

FIG. 12 illustrates a cross-section of a plain laminate after partial UV curing, made intentionally out of scale, of a laminate of the invention decorated by silk-screening on a side of the putty core (15), using at least one ink layer (34) made of unsaturated polyester resin, cured by mixed curing combining UV curing with chemical curing. The step of silk screening must be done shortly after the desired length of laminate is cut to separate it from the manufacturing line, while the core is partially cured. In the event the laminate being silk screened is a laminate that includes release films (1 and/or 7) on the upper and/or lower sides of the core, then the film covering the side of the core which will be silk screened must be removed to create a newly exposed face of said FRP structural putty core (15), prior to applying serigraphic ink (34). The figure shows schematically the variation of the polymerization along the thickness of the unsaturated polyester ink layer (34), evidencing by the different density of the lines that the outer surface of the ink layer is sufficiently cured so as to form a tack-free skin that allows the handling of the laminate, while the portion of the ink in contact with the putty core (15) remains, for a sufficient time, pasty and humid so as to allow the ink to chemical attack the substrate, fusing with it by cross-linking. The core (15) is also partially cured by the UV curing (21). The thickness and density of the lines in the cross-sectional view graphically represents the evolution of the polymerization at one particular moment in time during the hardening process.

FIG. 13 shows the same cross-section of the laminate illustrated in FIG. 12 after reaching full polymerization (hardness of around 50 Barcol degrees) by the action of chemical curing agents or by the action of a sequence of UV expositions, and suggests the total cross-linking or chemical fusion between ink and core. The higher density of the lines in the cross-section as compared to FIG. 12 graphically represents the bigger polymerization grade of the resin of the ink and the resin of the FRP core.

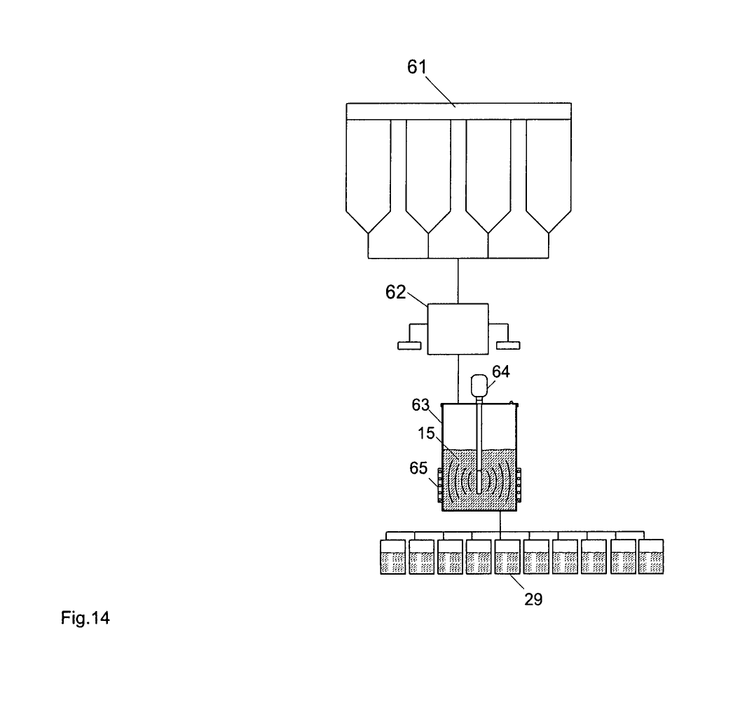

FIG. 14 shows an example of the process of manufacturing the putty of the invention, wherein resins and fibers are separately stored in storage system (61), metered in a metering unit (62), and mixed in a mixing tank (63), that has a high frequency vibration system (64) and a heat exchanger (65) arranged to it for forming the putty (15), which can be packaged in drums (29).

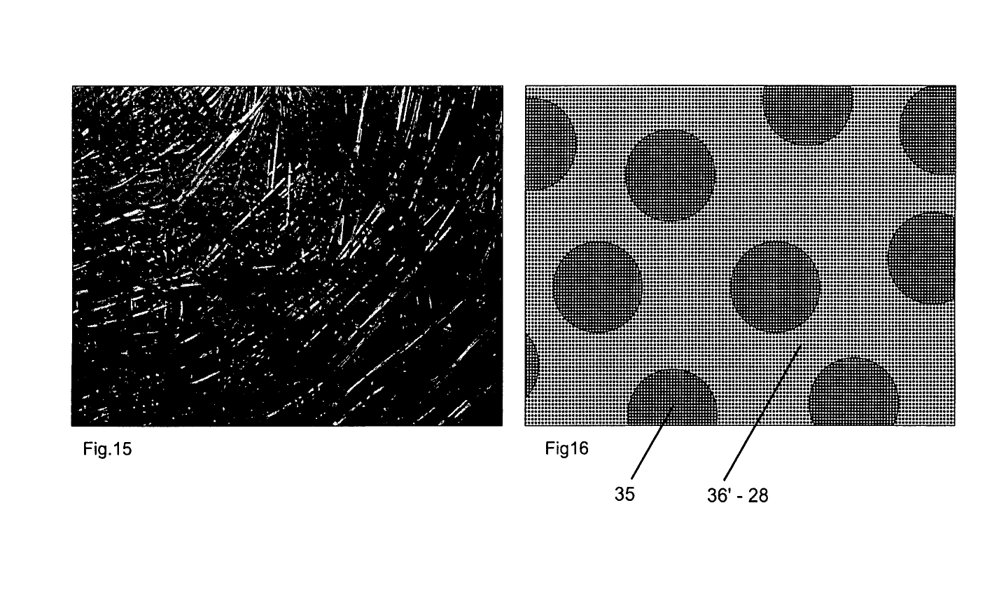

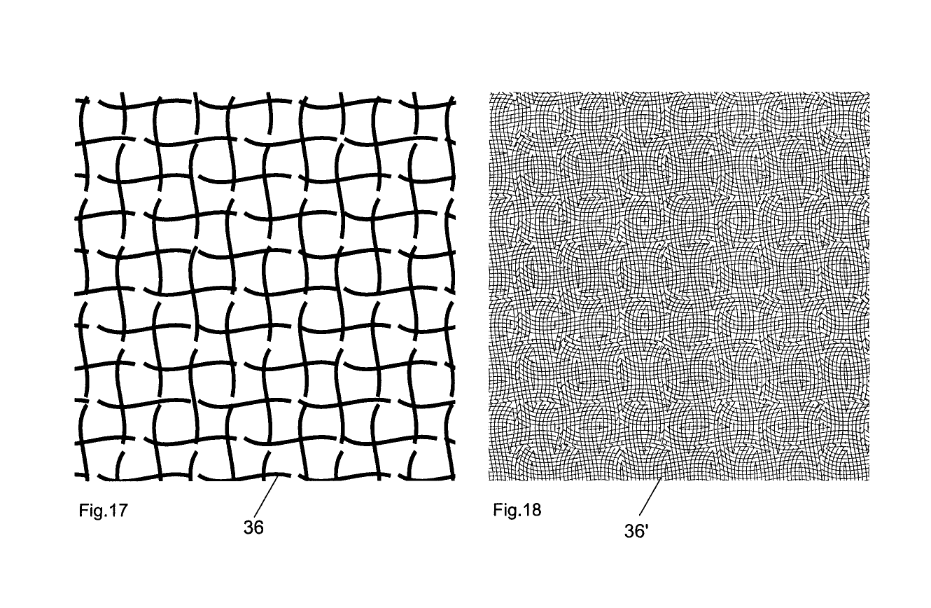

FIGS. 15, 16, 17, 18 show examples of the effect of the vibration on the glassfiber chopped strands. FIG. 15 shows a typical example of how glassfiber chopped-strands spread-out when they are sprinkled by the chopper, showing the spaces voids that are created because of their shape and interlacing. FIG. 16 is a theoretical macro-layout, showing the option of using a composition of two types of fiber soaked in resin, wherein chopped strands (35), of the type of fiber which has been left intact, are combined with monofilaments (36′) which have been broken down from the other type of chopped strands (36) (shown in FIG. 17). The intact chopped strands (35) are formed by monofilaments (35′) bonded together by the sizing. The single filaments (36′), once totally released from the original chopped strands (36) fill any available room (28) throughout the resin formed by the interlacing of the strands (35) that have been left intact. It is important to remark that the volume of the free spaces (28) between the strands (35), although intentionally emphasized in the figure, is substantially large. FIG. 17 and FIG. 18 show schematically an example of the effect of the vibration on the glassfiber chopped strands, when the fiber composition consists of only one type of fiber chopped strands (36) and it is totally broken down into monofilaments (36′). These figures, for easy visualization, have intentionally been drawn out of scale, mimicking just a few strands positioned in a theoretical layout.

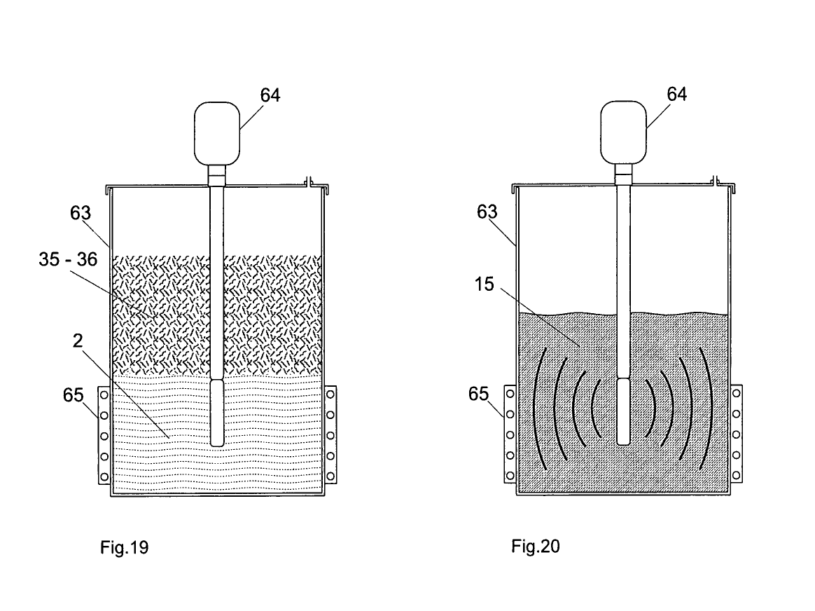

FIGS. 19 and 20 show an example of the wet-out of the fiber-resin mixture and the total breaking down of at least one type of chopped strands into monofilaments, wherein: (63) mixing tank, (64) high frequency vibration system, (35, 36) are types of chopped strands, (2) resin, (65) heat exchanger. As shown in FIG. 19, the chopped strands are laid over the resin and wet, or soaked, by absorption. In FIG. 20 all fiber is wet out by resin, the vibration system is activated, and the selected fiber is separated into monofilaments individually coated by the resin and dispersed therein to form the putty (15).

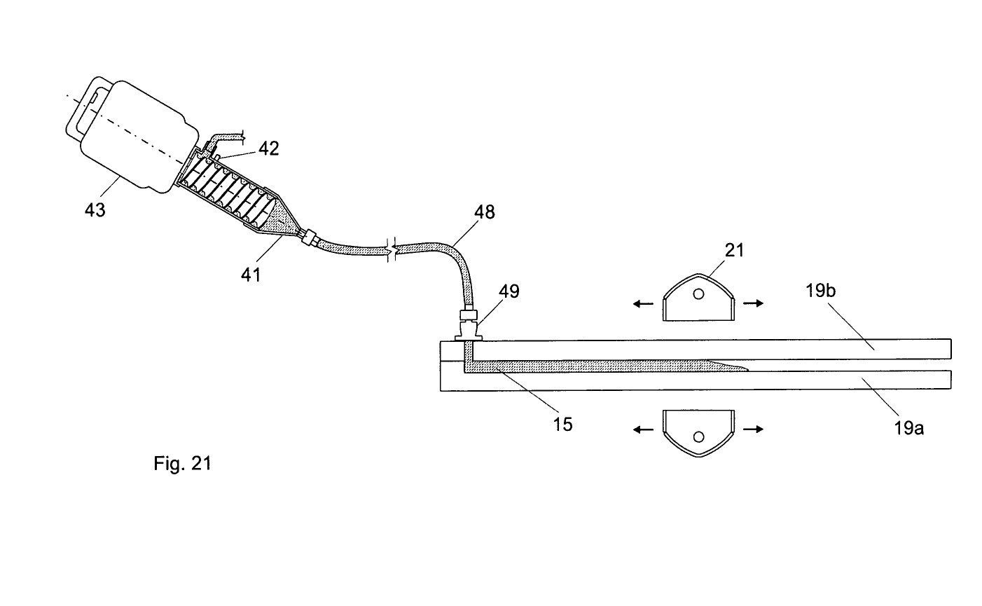

FIG. 21 shows an injection molding example of the invention, comprising a pump (43) for injecting the putty (15) between the mold halves (19, 19′), through a funnel (41) located at the end of the screw pump (43). A flexible hose (48) is connected to the inlet port (49) of the mold. The curing can be made by UV sources (21) right through one or more transparent portions of the mold. The UV sources (21) can be positioned to be static or movable, such that to scan the part, the UV sources (21) are moving on the surface of the mold. A valve (42) is included in the pump (43) for incorporate additives, processing aids, or chemical curing agents to the putty.

### Materials Used in the Putty and Gadgets Used in the Process for Manufacturing the Putty and the Parts

Although unsaturated polyester resin, glassfiber chopped strands reinforcement and UV and/or chemical-thermal curing agents are preferably used, any other resins, any other type of fiber, any other curing agents, compatible with the method, can be used. Similarly, although calcium carbonate, talc, fumed silica, glass spheres, spreading hydrogenated castor oil, BYK®-A 555 air releasing agent and BYK® W 966 fiber wetting agent are optional materials preferably used, any other compatible filler, additive and/or processing aids, compatible with the method, can be used. Although films used in the process of continuous lamination/pultrusion/extrusion are preferably plastic films, films made of other materials as aluminum foil or other metals, paper, or any other film compatible with the process can be used, either alone or in combination with plastic films. Likewise, although UV radiation for curing and screw pump for feeding the putty are the systems that are preferably, any other kind of radiation curing, such as electron beam and ultrasonic, and any other gadget for conveyance and feeding the putty, such as piston pump, gear pump and pressurized tank, compatible with the method, can be used.

While the invention has been described in detail with reference to the examples, modifications and variations of those embodiments will now be apparent to those skilled in the art. Accordingly, the scope of the invention is not to be limited by the details of the foregoing detailed description, but only by the terms of the appended claims.

1.-31. (canceled)

32. A radiation and/or chemical curable filamentized fiber reinforced molding putty compound, comprising a UV and/or catalyst curable resin and fiber reinforcement, including glassfiber monofilaments that were created by breaking down, or separating, at least one type of standard glassfiber chopped strands into indivisible and elementary fiber monofilaments, the monofilaments being homogeneously and isotropically dispersed within said resin composition, said glassfiber monofilaments having a diameter of between 1 and 50 μm and lengths between 3 and 50 mm, wherein the fiber reinforcement weight makes up between 10 and 50% of the total weight of the putty, and wherein said monofilaments are present in an amount necessary and sufficient to capillarily reinforce the resin thoroughly and everywhere in the putty, eliminating irregular shrinkages, waves and texture whatsoever on the surfaces of a part manufactured therefrom.

33. The putty compound according to claim 32, wherein the fiber reinforcement further includes at least one type of glassfiber chopped strands that has been left intact.

34. A device for producing a UV and/or catalyst curable filamentized fiber reinforced molding putty compound, comprising:
a material storage system for separately storing a UV and/or catalyst curable resin composition and a chopped fiber strands composition,
a mixing tank in which to mix said resin composition and said chopped fiber strands composition,
a metering system for releasing controlled amounts of each of the resin composition and the chopped fiber strands composition from the material storage system into said mixing tank,
a system for selectively heating or cooling the contents of said mixing tank,
a separation system arranged at the mixing tank,
wherein said separation system is capable of generating high frequency vibrations in the mixing tank to separate, once soaked into the resin composition, at least one type of the chopped fiber strands of said chopped fiber strands composition into monofilaments, and to disperse said monofilaments into the resin so as to thoroughly, capillarily reinforce the resin everywhere with fiber, thereby forming a UV and/or catalyst curable filamentized fiber reinforced molding putty compound.

35. A method for producing a UV and/or chemical catalyst curable filamentized fiber reinforced molding putty compound, comprising:
providing an unsaturated resin composition including UV and/or chemical catalyst curable resin,
providing a fiber composition formed by one or more types of chopped glassfiber strands,
adjusting the temperature of the resin to a predetermined process temperature,
adding the chopped glassfiber strands to the resin composition in a mixing tank,
allowing the chopped fiber strands to soak, undisturbed, in the resin composition until they have become wetted, thereby forming a mixture of resin and chopped glassfiber strands,
totally separating, or breaking down, at least one type of chopped glassfiber strands in the mixture into indivisible and elementary fiber monofilaments by means of a separation system, thereby forming a filamentized putty, and
adjusting the putty temperature to room temperature.

36. The method according to claim 35, wherein providing an unsaturated resin composition includes providing a resin composition having a viscosity necessary and sufficient to act as a lubricant so as to allow the fibers that compose the putty to slide smoothly relative to one another, and to flow when the putty is compressed during molding, said viscosity being obtained either by the resin formulation itself or by the addition of one or more of the group consisting of fillers, additives and processing aids;
and wherein the separating comprises generating high frequency vibrations.

37. The method according to claim 35, wherein providing a fiber composition comprises providing chopped fibers having lengths between 3 and 50 mm.

38. The method according to one of claims 35, wherein the combination of providing a fiber composition and the separating are performed in such a way as to yield filaments having a diameter within the range of 1 and 50 μm.

39. The method according to one of claims 35, wherein the providing a fiber composition further comprises providing at least two types of chopped glassfiber strands having properties such that the separating results in at least one type of chopped glassfiber strands being entirely broken down into indivisible and elementary fiber monofilaments while at least one type of chopped glassfiber strands is left intact,
and wherein the providing a fiber composition comprises providing chopped fibers in an amount such that the total weight of the fiber reinforcement makes up between 10 and 50% of the total weight of the putty, with the percentage of chopped fibers that are totally separated, or broken down, into indivisible and elementary fiber monofilaments in the separating being provided in an amount necessary and sufficient to capillarily reinforce the resin thoroughly and everywhere in the putty, eliminating irregular shrinkages, waves and textures whatsoever on the surfaces of a part manufactured therefrom and to provide a substantially colloidal state and a practically homogeneous consistency of the mixture, eliminating decantation of the fiber, whilst the chopped strands left intact allow fiber/resin ratios higher than the average FRP structures known in the art, which use only chopped strands.

40. A method for manufacturing a part using a UV and/or chemical catalyst curable filamentized fiber reinforced molding putty compound, including:
preparing a putty compound by using the method according to claim 4,
molding the putty compound by pressing, injecting, laminating, pultruding or extruding, the putty compound into or through a mold, and
curing the putty compound to produce a manufactured part.

41. The method according to claim 40, wherein the curing is carried out by chemical catalyst curing agents present in the putty compound.

42. The method according to claim 40, wherein said preparing comprises preparing said putty to include UV photoinitiators and/or chemical catalyst curing agents, and said curing is performed using one or more of the group consisting of:
a quick and full UV curing only, occurring entirely on the production line,
a mixed curing combining UV curing and chemical curing, said mixed curing comprising a first quick, partial curing by UV radiation made in the production line to a degree that the putty is sufficiently hardened so as to enable it to be handled, followed by a second slow and full curing by a room temperature chemical curing process that manifests itself after the part is removed from the production line and progresses during the storage of the manufactured part, with the total polymerization of the resin occurring after the part has been removed from the production line, and
a mixed curing comprising a first quick, partial curing by UV radiation made in the production line to a degree that the putty is sufficiently hardened so as to enable it to be handled, followed by a radiation made after the part is removed from the production line, with the total polymerization of the resin occurring after the part has been removed from the production line, and wherein said radiation is made by post-curing the part with one or more radiation expositions.

43. An FRP continuous laminate comprising:
a fiber reinforced plastic (FRP) structural core comprising a filamentized fiber premix, or putty, composite comprising unsaturated polyester resin and glassfiber reinforcement that has been cured, said core having a lower face and an upper face, a central area and two longitudinal edges, wherein
said glassfiber reinforcement or including monofilaments, having a diameter of between 1 and 50 μm, that have been broken down, or separated, from standard glassfiber chopped strands into indivisible and elementary fiber monofilaments and homogeneously and isotropically dispersed within said resin composition,
said glassfiber monofilaments having lengths between 3 and 50 mm,
said resin composition containing curing agents that are selected from a group consisting of chemical catalyst curing agents and UV curing agents, and
said longitudinal edges being straight, smooth, molded, uncut edges.

44. The laminate according to claim 43, wherein the weight of the glassfiber reinforcement in said core makes up between 10 and 50% of the total weight of the core, the glassfiber reinforcement being made of one of the group of fibers consisting of at least one type of chopped strands that has been entirely broken down into monofilaments, and at least one type of chopped strands that has been entirely broken down into monofilaments in combination with at least one type of chopped strands that has been left intact; the monofilaments of the glassfiber reinforcement having lengths between 3 and 50 mm; the percentage of the glassfiber reinforcement in the core that is in the form of monofilaments being present in the amount necessary and sufficient to capillarity reinforce the resin thoroughly and everywhere in the core, whereby said laminate is free from shrinkages, waves and textures whatsoever on the surfaces thereof, wherein in particular the fiber reinforcement is exclusively composed of filaments that have been entirely broken down from their original chopped strands chopped in one or more lengths.

45. The laminate according to one of claims 43, further comprising:
a lower film having a lower face and an upper face, said upper face of said lower film being covered with a first ink that is chemically bound thereto;
said lower face of said core being chemically bound to said first ink;
an upper film having a lower side and an upper side, said lower side of said upper film having a second ink thereon that is chemically bound thereto, as well as to the resin in the FRP core;
whereby said lower film, first ink, structural core, second ink and upper film are fused to form a laminate having a unitary body.

46. The laminate according to one of claims 45, wherein each of said upper and lower films are formed as a multifunctional film system with film layers for linking and film layers for finishing, all the films being capable of being printed upon,
said linking film layers being chemically bonded to said core and
said finishing film layers forming the outside surface of the laminate and having sufficient resistance to protect the laminate from scratches, cuts, and impacts thereto,
wherein all films that are bound to each other are bound by one or more resins selected from a group consisting of ink and an intervening adhesive resin, and
each of said multi-functional film systems and is in the form of a single polyvalent film layer adapted to be capable of linking, printing and finishing.

47. A device for producing a continuous laminate using a technique combining a spreader system and a pultrusion system for processing a filamentized fiber reinforced molding putty compound, the device comprising:
a structure having a longitudinal axis, said structure supporting a platform located at an initial end of such structure and a driving system located at a terminal end of such structure for hauling the laminate along said platform and through the device;
a lower film feeding system, for continuously supplying at least one lower film onto said platform;
a putty feeding system for forming onto said at least one lower film a layer of putty;
an upper film feeding system, for continuously supplying at least one upper film onto said platform such that it lies on top of said putty layer, thereby encapsulating said putty between said at least one lower film and said at least one upper film, such that they form a continuous strip;
a pultrusion system for shaping the putty layer to its final thickness and width;
said pultrusion system comprising a spatula, a lower flat surface provided by said platform on which said lower film travels, and a number of lateral walls positioned to limit the lateral spread of said putty so that the laminate is produced with a final width and requires no cutting or trimming of its longitudinal edges or additional operations for its finish;
a UV curing system positioned for curing said laminate as it travels through a mold selected from the group consisting of a stretching mold or structure and a corrugation or grooving mold, with a first set of UV sources positioned exactly where the putty is being shaped in the pultrusion system, and
a transverse cutting system for severing a desired length of completed laminate.

48. A method of manufacturing an FRP continuous laminate combining a spreader system and a pultrusion system for processing a putty, said method comprising:
providing a device having a platform located at an initial end and a driving system located at a terminal end for hauling the laminate along said platform and through the device;
dispensing a lower film onto said platform so that the lower side of said lower film faces downward and travels on said platform, and the upper side of said film presents an upwardly facing surface;
spreading a layer of putty such that it covers the upwardly facing surface of said lower film, with the putty layer constituting, when the laminate is completed, a structural core of the laminate;
dispensing an upper film onto the upwardly-facing surface of said putty such that said lower side of said upper film contacts said upwardly-facing surface of said putty, whereby the putty is encapsulated between the lower film and the upper film, with the lower film, the putty, and the upper film together forming a laminate having a lower face, an upper face, and first and second longitudinal edges;
hauling the laminate through a pultrusion system for shaping the putty layer to its final thickness and width;
further hauling said laminate through a stretching mold or structure or a corrugation or grooving mold for shaping the cross section of the laminate;
curing said laminate as it travels through the selected mold;
transversely cutting a desired length of completed laminate.

49. The method according to claim 48, wherein:
the dispensing a lower film onto said platform comprises dispensing a film having an upper side which has been preprinted with a first ink that is chemically bound thereto to form a composite having a lower side and an upper side; said ink being capable of acting as a gelcoat layer; and
the dispensing said upper film onto the upwardly-facing surface of said putty comprises dispensing a film having a lower side which has been preprinted with a second ink that is chemically bound thereto to form a composite, said upper film being dispensed onto the upwardly-facing surface of said putty such that said preprinted lower side of said upper film contacts said upwardly-facing surface of said putty layer, whereby the putty is encapsulated between the lower film and the upper film, with the lower film, the putty layer, and the upper film together forming a laminate having a lower face, an upper face, and first and second longitudinal edges.

50. The method according to claim 48, wherein said curing utilizes a system comprising one or more of the group consisting of:
a quick and full UV curing only, occurring entirely on the production line,
a mixed curing combining UV curing and chemical curing, said mixed curing comprising a first quick, partial curing by UV radiation made in the production line to a degree that the putty is sufficiently hardened so as to enable it to be handled, followed by a second slow and full curing by a room temperature chemical curing process that manifests itself after the part is removed from the production line and progresses during the storage of the manufactured part, with the total polymerization of the resin occurring after the part has been removed from the production line, and
a mixed curing comprising a first quick, partial curing by UV radiation made in the production line to a degree that the putty is sufficiently hardened so as to enable it to be handled, followed by a second radiation made offline, after the part is removed from the production line, with the total polymerization of the resin occurring after the part has been removed from the production line, and wherein said radiation is made by post-curing the part with one or more radiation expositions.

51. A method of manufacturing an FRP continuous plain laminate combining a spreader system and a pultrusion system for processing a putty, said method comprising:
providing a device having a platform located at an initial end and a driving system located at a terminal end for hauling the laminate along said platform and through the device;
dispensing an endless, recirculating loop of lower release film onto said platform so that the lower side of said lower film faces downward and travels on said platform, and the upper side of said film presents an upwardly facing surface;
spreading a layer of a putty such that it covers the upwardly facing surface of said lower film, with the putty layer constituting, when the laminate is completed, a structural core of the laminate, said core having first and second longitudinal edges;
dispensing an endless, recirculating loop of upper film onto the upwardly-facing surface of said putty such that said lower side of said upper film contacts said upwardly-facing surface of said putty, whereby the putty is encapsulated between the lower film and the upper film;
hauling the lower film, the putty, and the upper film through a pultrusion system for shaping the putty layer to its final thickness and width;
further hauling the lower film, the putty, and the upper film through a stretching mold or stretching structure;
curing said putty as it travels through the mold to form said core of the laminate;
allowing said laminate to travel along the platform beyond the extent of the endless lower film and endless upper film, whereby the laminate is traveling alone, without any films, thereby constituting a plain laminate;
transversely cutting a desired length of completed plain laminate.
